(19) United States
(12) Patent Application Publication
(10) Pub. No.: US 2011/0010456 A1
(43) Pub. Date: Jan. 13, 2011

(54) RECORDING MEDIUM STORING LOAD-DISTRIBUTION PROGRAM, LOAD-DISTRIBUTION APPARATUS, AND LOAD-DISTRIBUTION METHOD

(75) Inventor: Toshiaki SAEKI, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/829,761

(22) Filed: Jul. 2, 2010

(30) Foreign Application Priority Data
Jul. 8, 2009 (JP) 2009-161719

(51) Int. Cl. G06F 15/173

(52) U.S. Cl. 709/226

(57) ABSTRACT

A load-distribution by a computer is provided where a plurality of data centers provide a customer system with a computational resource. A computational resource request is received from a customer system. Electric power information for each data center, which can specify an amount of power consumption required for providing a computational resource from each data center, is acquired in response to the computational resource request. A data center from the plurality of data centers is selected based on the amount of power consumption. The selected data center is requested to provide the computational resource to the customer system.

### CROSS-REFERENCE TO RELATED APPLICATIONS

This application is based upon and claims the benefit of priority of the prior Japanese Patent Application No. 2009-161719, filed on Jul. 8, 2009, the entire contents of which are incorporated herein by reference.

### FIELD

The embodiments discussed herein are related to a technology for selecting a computational resource that performs processing served as a load distribution object.

### BACKGROUND

Service of offering computational resources for performing information processing in customer service in company or the like is commonly performed. An entrepreneur who offers this service in large scale owns a data center having computational resources, such as a plurality of servers and storages. Physical computational resources that belong to the data center are used for constituting virtualized computational resources. The data center provides the customer system with the virtualized computational resource and the customer system is then allowed to perform its information processing using such virtualized computational resource. However, the customer system using the virtualized computational resource cannot recognize the original physical computational resource from the virtualized one. Here, the virtualized computational resource provided in this way can be realized using a technology, such as a virtual machine (VM) or a virtual local area network (VLAN).

Furthermore, when providing the customer system with the virtualized computational resource in this way, the entrepreneur may select one among the physical computational resources. For performing the appropriate selection, the following technology has been proposed. That is, while assigning a certain computational resource and performing customer service processing, a load-distribution apparatus monitors the response of the customer service processing.

Subsequently, if the response does not satisfy contract terms with customer, the load-distribution apparatus selects a specific computational resource that satisfies the desired processing performance and then reassigns processing.

Here, as described above, the entrepreneur who performs the service of providing customer systems with computational resources in large scale has data centers distributed all over the word. In each data center, furthermore, a number of computational monitors are worked with an enormous amount of power consumption.

In contrast, an electric power company generally sets up graduated electricity rates to equalize variations in power consumption through the whole society; a higher electricity rate is provided for a time period with higher power consumption, while a lower electricity rate is provided for a time period with lower power consumption.

In addition to the use of such a billing system for electricity rate can prevent an increase in electricity rate, another technology for avoiding an increase in power consumption in a predetermined time period throughout the entire society has been proposed as follows: For example, an image-forming apparatus is designed so that an image output to paper can be performed in a time period other than other periods with high electric-power consumption if a time period from job entry to output included in such a high power consumption period. In addition, if there is a time period with a midnight discount power rate, outputs are carried out all together within such a time period.

However, in the service of providing a customer system with a virtualized computational resource as described above, a object of processing with the computational resource is not always one adaptable to batch processing and, in many cases, real-time processing should be carried out if required depending on customer service.

Therefore, there is a limit in adjusting a time period for providing a computational resource. Furthermore, in the aforementioned technology of selecting a specific computational resource when a response does not satisfy the contract terms with a customer, a load-distribution apparatus cannot select a computational resource while focusing attention on the power consumption of the computational resource. Furthermore, the power consumption of a computer varies in every provided service because of differences in I/O load, memory usage, and so on of the computer in every service. In the related art, therefore, the selection of a computational resource in consideration of power consumption has not been successfully performed in a service that provides a customer system with a computational resource.

In view of the aforementioned programs, the present invention has been made in consideration of required power consumption in providing a computational resource to a customer system and intends to realize an appropriate operation of a computational resource.

### SUMMARY

A load-distribution method is performed by a computer connecting to a plurality of data centers by a network, where the data center constructs a virtual computational resource and provides a customer system with the computational resource. The method receives from a customer system a providing request of computational resource. The method acquires electric power information for each data center, which can specify the amount of power consumption required for providing a computational resource from each data center in response to the providing information, when receiving the providing information of computational resource. The method selects one or more data center(s) from the plurality of data centers based on the amount of power consumption. The method transmits to the selected data center the providing request of computational resource to the source customer system of the providing request.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF THE DRAWINGS

Embodiments are illustrated by way of example and not limited by the following figures.

FIG. 1 is a diagram illustrating the entire configuration of a load-distribution system according to a first embodiment;

FIG. 2 is a block diagram illustrating the entire configuration of a load-distribution apparatus according to the first embodiment;

FIG. 3 is an explanatory diagram illustrating an operating information table according to the first embodiment;

FIG. 4 is an explanatory diagram illustrating an example of data that represents performance requirements and computational resources;

FIG. 5 is a flowchart representing the processing of the load-distribution apparatus of the first embodiment;

FIG. 6 is a flowchart representing the processing of the load-distribution apparatus of the first embodiment;

FIG. 7 is an explanatory diagram representing a list that includes the index values of the respective data centers in the first embodiment;

FIG. 8 is a diagram illustrating the entire configuration of a load-distribution system according to a second embodiment;

FIG. 9 is a diagram illustrating the entire configuration of a modified example of the load-distribution system according to the second embodiment;

FIG. 10 is a diagram illustrating the entire configuration of a load-distribution system according to a third embodiment;

FIG. 11 is a block diagram illustrating the configurations of the respective load-distribution apparatuses in the system according to the third embodiment;

FIG. 12 is a flowchart representing the processing of the load-distribution apparatus (client) of the third embodiment;

FIG. 13 is a flowchart representing the processing of the load-distribution apparatus (server) of the third embodiment; and

FIG. 14 is a flowchart representing the processing of the load-distribution apparatus (client) of the third embodiment.

### DESCRIPTION OF EMBODIMENTS

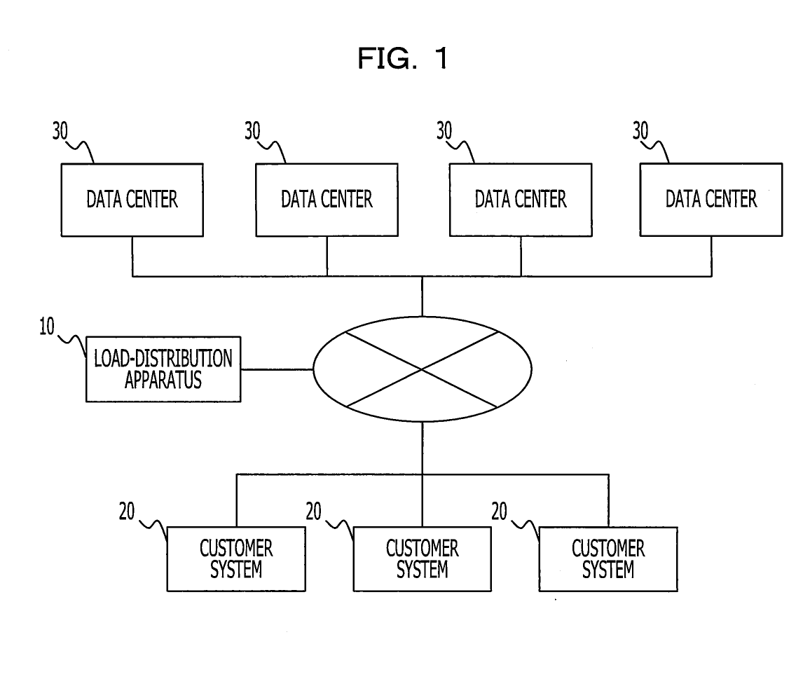

FIG. 1 illustrates the entire configuration of a load-distribution system according to a first embodiment of the present invention. The load distribution system includes a load-distribution apparatus 10, one or more customer system 20 and two or more data centers 30.

The load-distribution apparatus 10, the customer systems 20, and the data centers 30 are mutually connected to one another through network.

Specifically, in the following, the description about the processing carried out by the customer system 20 refers to the processing carried out by any of computers included in the customer system 20. Specifically, the description about the processing carried out by the data center 30 refers to the processing carried out by any of computers included in the data centers 30 (the same applies to other embodiments).

The load-distribution apparatus 10 is a server (computer) that includes at least a central processing unit (CPU) and a storage device. Here, the storage device refers to one or both of a volatile storage device, such as a memory, and a nonvolatile storage device, such as storage. The load-distribution apparatus 10 acquires the operation information of each data center 30 and then selects the data center 30 that offers a computational resource in response to a providing request of the computational resource from the customer system 20. Then, the load-distribution apparatus 10 transmits an instruction to the selected data center 30 so that the customer system 20 may be provided with the computational resource.

The customer system 20 is a computer system operated by the customer who receives the service provided by the computational resource. Each of the customer systems 20 transmits the providing requests of the computational resources to the load-distribution apparatus 10 according to the operation or the like by the customer, respectively. At this time, in response to the providing request of the computational resource, each customer system 20 transmits performance requirements that represent the performance required for the computational resource with respect to the providing request.

The data centers 30 include computational resources, such as servers and storages, respectively. Each of the data centers 30 can transmit or make available for retrieval own operation information to the load-distribution apparatuses 10 every predetermined time. In addition, each of the data centers 30 constructs a virtual computational resource using physical computational resources included in the data center 30 when it receives from the load-distribution apparatus 10 a providing request of computational resource to the customer system 20. Furthermore, the data center 30 offers the constructed virtual computational resource to the customer system 20 through the network. In other words, the computational resource of the data center 30 carries out the processing of the customer system 20 (processing as a load-distribution object) as part of the computational resource of the customer system 20.

Here, the above operating information of a data center 30 can include, for example, electric power information by which the amount of electric consumption is identifiable when a computational resource is provided in response to the providing request from the customer system 20 in each data center; electricity rate information by which an electricity rate per unit electric energy in each data center; and/or performance information of computational resources in data centers 30.

The electric power information includes operation power consumption which is the electric power [W] required for the operation of a server itself used for constructing one virtual machine. In addition, the electric power information also includes cooling power consumption which is the electric power [W] required for the cooling of a server used for constructing one virtual machine. Furthermore, the electric power information includes a power/performance ratio that represents a throughput per unit electric power (mips/W) in the server to be provided as a providing object.

Furthermore, the electric rate information includes an electricity price/cost rate per unit electric energy (yen/kWh) in each data center 30. Furthermore, the performance information can include, for example, the throughput, redundancy, and/or response speed of the computational resource. The throughput of a computational resource includes a “million instructions per second” (MIPS) capacity and a memory capacity of a virtual server (virtual machine) which can be constructed using the physical computational resource of the data center 30. In addition, the redundancy includes information that represents the presence or absence of power redundancy as well as the presence or absence of network redundancy. Furthermore, the response speed is a time period from the sending of a request to the reception of a response on one side in a communication between each data center 30 and each region where the customer system 20 exists.

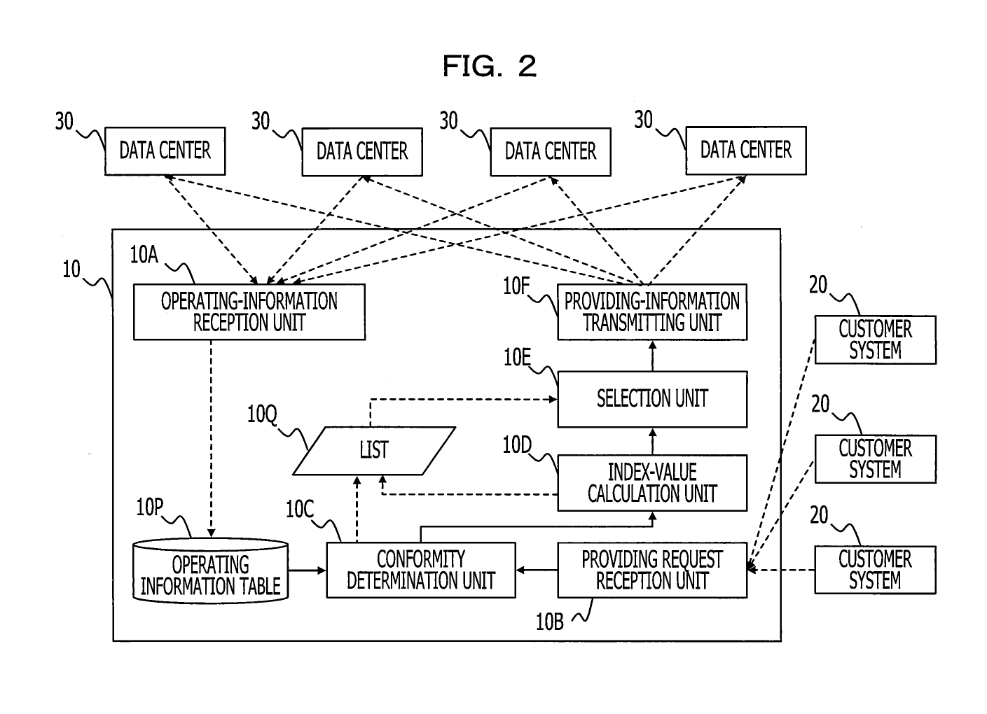

Next, the configuration of the load-distribution apparatus 10 will be described. FIG. 2 is a block diagram illustrating the configuration of the load-distribution apparatus 10. The load-distribution apparatus 10 includes an operating information table 10P. The operating information table 10P is held in a storage device installed in the load-distribution apparatus 10. In addition, a load-distribution program is executed by the CPU of the load-distribution apparatus 10 and then cooperates with hardware devices, such as the storage device, an input/output device, and a communication-realizing port (hereinafter, also referred to as a communication port). As a result, an operating-information reception unit 10A, a providing-request reception unit 10B, a conformity determination unit 10C, an index-value calculation unit 10D, a selection unit 10E, and a providing-information transmitting unit 10F are implemented.

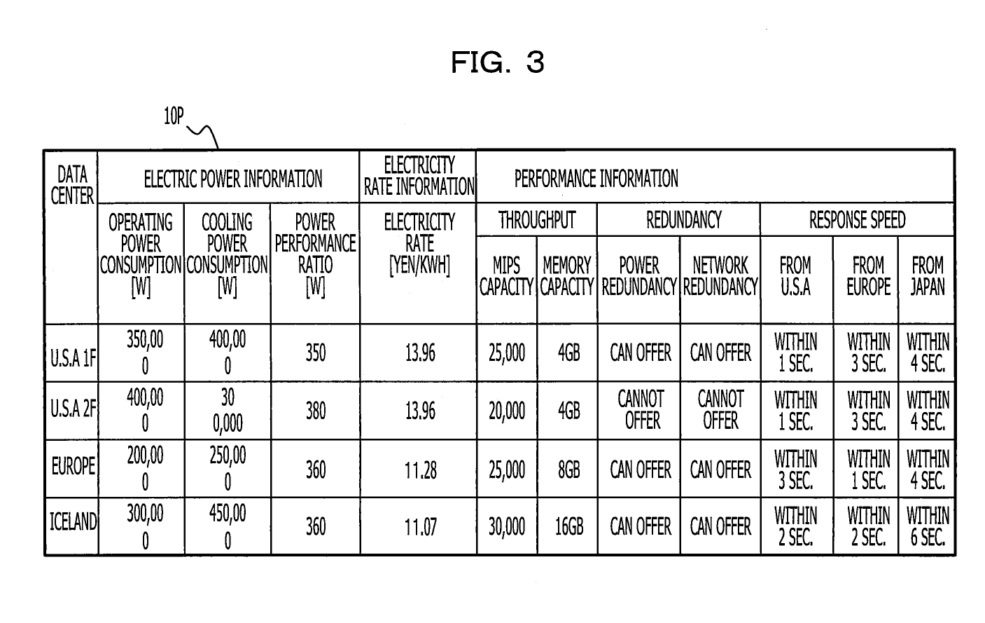

The operating information table 10P is a table in which the operating information received from each data center is stored. As shown in FIG. 3, the operating information table 10P includes the electric power information, electricity rate information, and performance information of each data center 30, as shown in FIG. 3.

The operating information reception unit 10A receives the operating information from the respective data center 30 every predetermined time through the communication port to each data center 30 and then stores the operating information in the operating information table 10P.

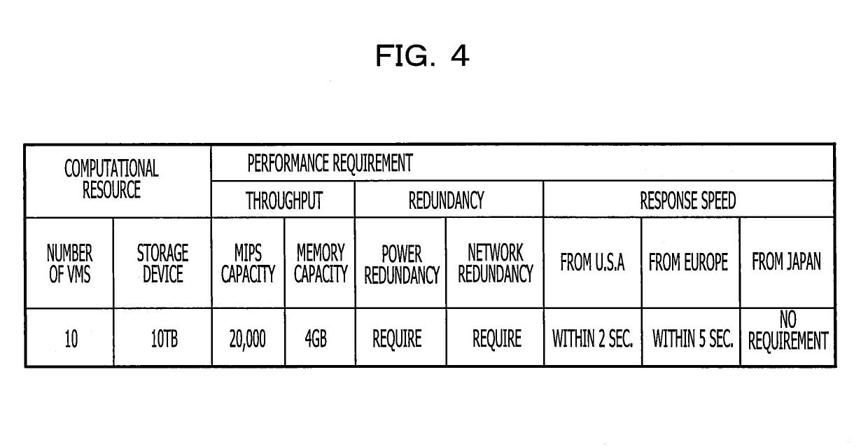

The providing request reception unit 10B receives the providing request of a computational resource from one or more customer systems 20 via the port which realizes communication with each customer system 20. Here, this providing request contains the amount of computational resources required for needed with customer system 20. The amount of computational resources may be the number of virtual machines or the capacity of the storage. Furthermore, the providing request may include the performance requirements. The contents of the performance requirements correspond to the performance information about the computational resource of the data center 30, including the throughput, redundancy, and response speed of the computational resource. Furthermore, FIG. 4 is an example of the data that represents the computational resource and the performance requirement included in the providing request of the computational resource. In addition, the providing request reception unit 10B also has a function of notifying the customer system 20 of the contents of the provided computational resource through the communication port to the customer system 20 when the selected data center 30 responds to the providing instruction of the computational resource (such a function is not shown in FIG. 2).

Among a plurality of data centers 30, the conformity determination unit 10C specifies the data center that can conform or comply with the performance request, which is included in the providing request of the computational resource from the customer system 30, with reference to the operating information table 10P. Then, the conformity determining part 10C generates a list 10 Q that represents the data center 30 adapted to/complies with the performance request.

As a specific example, if the providing request reception unit 10B receives the performance requests shown in FIG. 4 from the customer system 20 and the operating information of the data center corresponds to the contents of the operating information table 10P shown in FIG. 3, the data center adapted to the performance requirements of the customer system 20 is as follows: In the redundancy of the operating information table 10P, the power redundancy and the network redundancy are impossible in the data center in “U.S.A 2F”. Thus, the data center in “U.S.A 2F” does not adapt to the requirement that the power redundancy is required for the performance requirements of the customer system and also does not adapt to the requirement that the network redundancy is required for the performance requirements thereof. In addition, the data center in Europe does not adapt to the requirement of within two seconds in the performance requirements of the customer system 20 because the response speed from U.S.A is within three seconds. Therefore, the data centers adapted to the performance requirements of the customer system are only those in “U.S.A 1F” and “Iceland”.

For each of the data centers 30 listed in the list 10Q, the index-value calculation unit 10D calculates an index value based on the electric power information and the electricity rate information stored in the operating information table 10P. The index value is used for selecting the data center 30 that provides a computational resource. The index-value calculation unit 10D makes the data centers 30 in the list 10 Q correspond to the respective calculated index values and then registers them.

Subsequently, the index-value calculation unit 10D sorts the data centers listed in the list 10Q with reference to the contents of their respective index values. A concrete method of calculating the index values and a concrete method of sorting the data centers will be described later.

Among the data centers 30 listed in the list 10Q, the selection unit 10E selects the leading data center 30 as one from which a computational resource will be supplied.

Through the communication port connected to each data center 30, the providing-information transmitting unit 10F transmits a request of providing the customer system 20 with the computational resource to the selected data center 30. Furthermore, the providing-information transmitting unit 10F receives a response that shows whether the instruction-received data center 30 accepts or rejects the providing instruction of the computational resource. The providing-information transmitting unit 10F also has a function of notifying the response to the selection unit 10E.

The providing-request reception unit 10B serves an example of each of a receiving function, a reception unit, and receiving procedure. Furthermore, the operating-information reception unit 10A, the conformity determination unit 10C, the index-value calculation unit 10D, and the selection unit 10E serve as examples of a selection function, a selection unit, and a selection procedure, respectively. In addition, the instruction transmission unit 10F serves as an example of a transmission function, a transmission unit, and a transmission procedure.

On the other hand, the data center 30 which has received the instruction from the load-distribution apparatus 10 determines whether it accepts or rejects the providing instruction of the computational resource from the load-distribution apparatus 10, for example with reference to the computational resource which can be supplied at the time of receiving the instruction. In other words, at the time of receiving the instruction, the data center 30 responds to the providing instruction of the computational resource when the computational resource which can be supplied from the data center 30 adapts to one requested by the customer system 20. On the other hand, the data center 30 denies the providing instruction of the computational resource when the computational resource which can be supplied from the data center 30 cannot be adapted to one requested by the customer system 20.

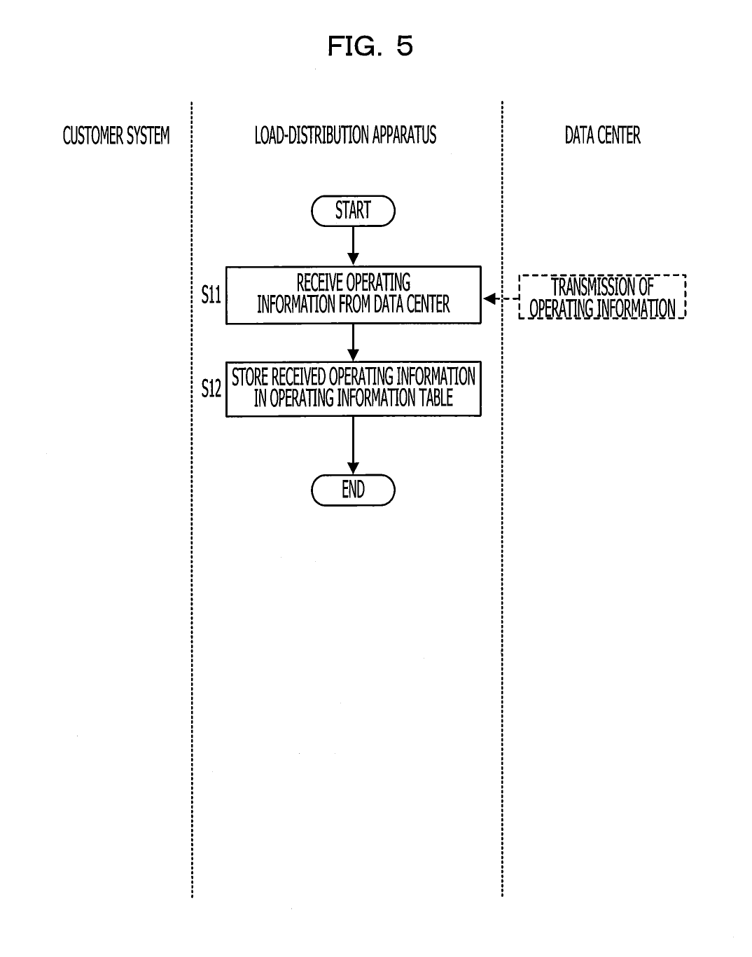

Next, the processing that the load-distribution apparatus 10 performs will be described. FIG. 5 is a flowchart representing the processing of the load-distribution apparatus 10 when the operating information is received from the data center 30 every predetermined time.

From each of the data center 30, the operating-information reception unit 10A receives the operation information including electric power information, electricity rate information, and performance information (S11). Then, the operating-information reception unit 10A stores the received operating information in the operating information table 10P for every data center 30 (S12).

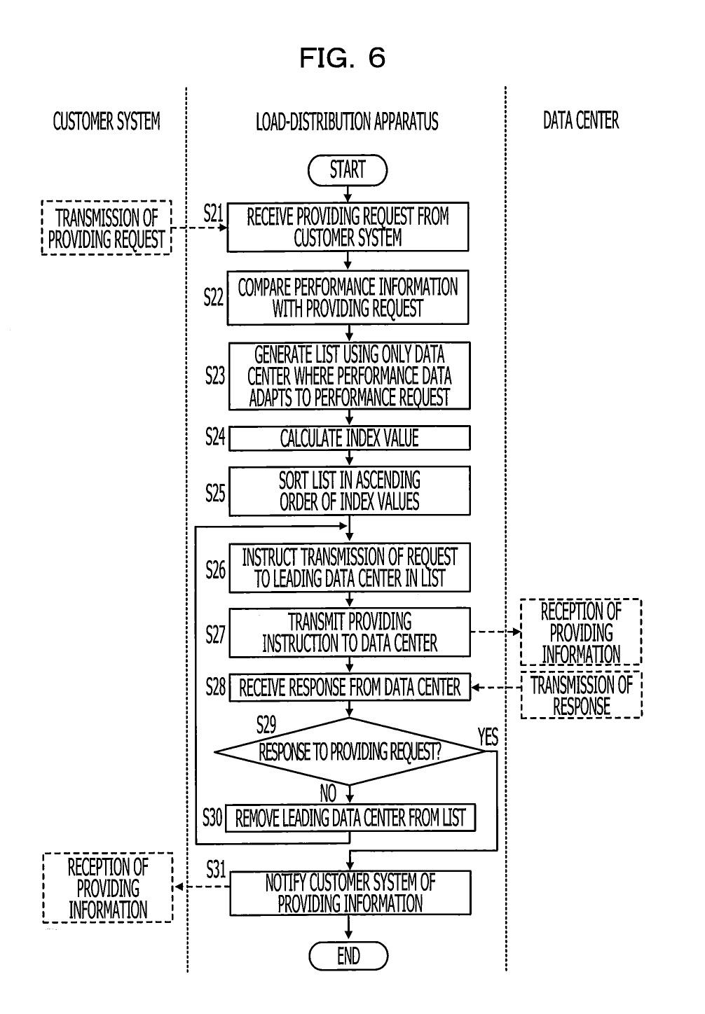

FIG. 6 is a flowchart representing the processing of the load-distribution apparatus 10 when the providing request of the computational resource is received from the customer system 20. The providing-request reception unit 10B receives the providing request of the computational resource from the customer system 20 (S21). Then, the providing-request reception unit 10B holds the contents of the providing request of the computational resource on the storage device installed in the load-distribution apparatus 10.

The conformity determination unit 10C compares the performance information included in the operating information of each data center 30 with the performance requirement included in the providing request received from the customer system 20 with reference to the operating information table 10P (S22). Among the data centers 30, the conformity determination unit 10C specifies the data center 30 where the performance information thereof adapts to the performance requirement of the customer system 20 among each data center 30. Furthermore, the determining part 10C generates a list 10Q representing the specified data center 30 and then holds the list 10Q on the storage device installed in the load-distribution apparatus 10 (S23).

For each of the data centers 30 listed in the list 10Q, the index-value calculation unit 10D calculates an index value based on the electric power information and the electricity rate information stored in the operating information table 10P (S24). Subsequently, the index-value calculation unit 10D further adds to the calculated index value to the list 10Q and then sorts the data centers listed in the list 10 Q with reference to the contents of their respective index values (S25).

The selection unit 10E selects the leading data center 30 of the list 10Q as one from which a computational resource will be supplied. Then, the selection unit 10E notifies an instruction to the providing-information transmitting unit 10F so that the providing request of the computational resource can be transmitted to selected data center 30 (S26).

The providing-information transmitting unit 10F transmits an instruction of providing the customer system 20 with the computational resource to the data center 30 selected by the selection unit 10E in response to the instruction of transmitting the providing request of the computational resource notified from the selection unit 10E (S27). From the data center from which the providing request of the computational resource has been transmitted, the providing-information transmitting unit 10F receives a response that shows whether it responds to or rejects the providing instruction (S28). If the data center responds to the providing instruction, this response includes a computational resource to be supplied from the data center 30. Then, the providing-information transmitting unit 10F notifies the contents of the received response to the selection unit 10E. If there is no response within a predetermined time, then the providing-information transmitting unit 10F performs processing as if a response of rejecting the providing instruction has been received.

Subsequently, the selection unit 10E determines whether the response from the data center 30 is provided for responding to or rejecting the providing instruction (S29).

If the data center 30 rejects the providing instruction, the selection unit 10E removes the leading center from the list 10Q (S30) and then returns to the above step S26. As a result of removing the leading data center 30 in this way, in the step S26, the selection unit 10E selects the subsequent data center 30 as one from which a computational resource is supplied.

On the other hand, if the determination in the step S29 results in that the data center 30 responds to the providing request, the providing-request reception unit 10B notifies the customer system 20 of the contents of the supplied computational resource (S31).

Now, a concrete example of a method of calculating an index value when the operating information of each data center 30 shown in FIG. 3 is received will be described.

An example of a computational expression used for the calculation is represented as follows:

$$\frac{C + S}{S} \times \frac{1}{R} \times \frac{F}{3600 \times 1000}$$

In the expression, “C” represents cooling power consumption [W]; “S” represents operating power consumption [W]; “R” represents a power performance ratio [mips/W]; and “F” represents an electricity rate [Yen/kWh]. Here, “R” may be a value of another power performance rate (for example, [flops/W]) as long as it represents processing performance per unit electric power.

The first term

$$\frac{C + S}{S}$$

of the above expression is a scale factor of the sum of the cooling power consumption and the operating power consumption per operating power consumption. For example, if the first term is 1.8, then the operating power consumption of the server that consumes 200 [W] alone is 1.8×200=360 [W], including the cooling power consumption required for cooling the server.

The second term

$$\frac{1}{R}$$

is a value that represents the amount of operating power consumption [J] that represents the required amount of electricity when a predetermined amount of processing is performed in the server (here, when the number of unit commands (one million commands) is executed). For example, if there is a server of 80,000 [mips] at a power consumption of 400 [W], the power performance ratio R is 80000/400=200 [mips/w] and 1/200=0.005 [J] is required for executing one million commands in the server.

The amount of power consumption can be derived from multiplying the first term with the second term, considering the power consumption required for cooling a server to be provided as a subsequent providing object. For example, in the data center 30, if the first term is 1.8 and the second term is 0.005 [J], then 1.8×0.005=0.009 [J] per million commands, including the power consumption for cooling, is required when the server is used for providing a computational resource. In other words, the result of multiplying the first term with the second term corresponds to the amount of operating power consumption [J] which is the amount of electricity required for executing one million commands in the server, a computational resource served as a next providing object, and the amount of cooling power consumption [J] which is the amount of electricity required for cooling the server when one million commands are executed in the server. The amount of the power consumption of the sum is not computed based only on power consumption of the server. It is the amount of power consumption required for the predetermined amount of processing of executing one million commands, or the amount of power consumption in consideration of the throughput of the server.

In the third term

$$\frac{F}{3600 \times 1000} ,$$

units are lined up and expressed as [Yen/Ws]=[Yen/J] because the unit of an electricity rate typically represented by an electric power company is expressed by [Yen/kWh]. According to the above expression, in the data center 30, the electricity rate [Yen] required for a predetermined amount of processing in the server to be used for constructing one virtual machine can be calculated based on the sum of the amount of the operating power consumption and the amount of cooling power consumption. Furthermore, when using the electricity rate as an index value, the sorting of the list 10Q in the index-value calculation unit 10D is carried out in order of cheap to expensive electricity rate, or in ascending order of index values. Therefore, among the data censer 30 represented by the list 10Q, the selection unit 10E can select a data center 40 with the cheapest electric rate for performing the same processing.

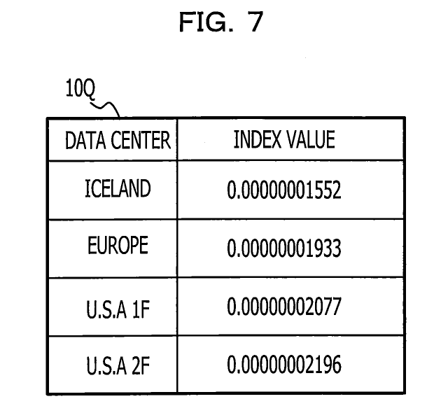

For example, on the basis of the operating information of each data center 30 shown in FIG. 3, the index values of the respective data centers 30 correspond to those shown in FIG. 7, respectively, when the index values are calculated using the aforementioned expression. In other words, as a result of calculating an index value based on the power consumption for cooling the server, the power consumption for operating the server, the power performance ratio of the server, and the electricity rate of the server in each data center 30, it is found that the index value of the data center 30 in “Iceland” is the lowest. FIG. 7 shows the results of sorting the data centers of the list 10Q by index value into in ascending order in the index-value calculation unit 30D. By the way, the above expression is based on the premise that, in each data center 30, the amount of computational resources newly supplied is smaller than the amount of computational resources already supplied and an influence of newly supplying any computational resource on other index value(s) is small. However, on the other hand, if there is almost no supplied computational resource, the data center 30 has a sufficient capacity and the index value thereof is then considered to be zero (0) and predominantly provided with a computational resource.

Furthermore, the data center 30 is based on the premise that it is being kept at an appropriate temperature by cooling or the like. If the temperature of any computational resource is not kept at an appropriate temperature due to poor cooling capacity, any additional computational resource cannot be supplied. Thus, the index value may be assumed to be infinite so as to prevent the computational resource from being supplied.

Furthermore, if the performance and power consumption of the computational resource can be specified, an index value can be calculated not only by the server but also by any of other computational resources in a similar manner. According to this kind of the load-distribution system, the load-distribution apparatus 10 selects the data center 30 that supplies any computational resource to the consumer system 20 on the basis of the amount of power consumption, the amount of cooling power consumption, and electricity rate which are required when a computational resource is supplied from each of the data centers 30. Therefore, it becomes possible to realize the operation of an appropriate computational resource in consideration of the amount of power consumption required for operating a computational resource in the data center and the electricity rate required therefore through the whole load-distribution system.

Here, as described above, the index value is used for selecting the data center 30 provided for the supply of computational resource and serves as a criterion for the selection of data center 30. In other words, the data center 30 is selected in consideration of the contents of the data center 30 reflected in the index value.

Furthermore, the selection of data center 30 does not always consider both the electric power information and the electricity rate information. As in the case of the aforementioned computational expression, all of the amount of operating power consumption, the amount of cooling power consumption, and the electricity rate are not always required to be reflected in the index value.

In other words, to take into consideration of at least the power consumption in each data center 30, the electric power information received from each data center 30 may include the information which is capable of specifying the amount of power consumption required for supplying a computational resource from each data center in response to the providing request. For example, such electric power information may include the information which is capable of specifying the amount of operating power consumption. For example, this information may be the amount of operating power consumption itself or the power performance ratio of the server. Alternatively, such information may be the operating power consumption and the time required for a predetermined amount of processing performed in the server. Furthermore, the index-value calculation unit 10D sorts the data centers 30 using the amounts of the operating power consumption thereof as an index value in ascending order of index values. Thus, the data center 30 with a smaller amount of the operating power consumption can be selected, dominantly. Therefore, the selection unit 10E can select the data center 40 with a small amount of power consumption in operation of a computational resource when making comparison among the data centers 40 with respect to the same amount of processing performed on the computational resource. Furthermore, as is evident from the specific example of the aforementioned computational expression, the data center 30 can be selected in consideration of the power consumption required for operating a computational resource as long as a value equivalent to the amount of operating power consumption is substantially reflected on the computational expression of the index value even if the amount of operating power consumption itself does not serve as an index value.

Here, for example, if the entrepreneur of service offering computational resources owns a plurality of data centers 30 around the world, some data centers 30 may be located at places in daytime and other date centers 30 may be located at places in nighttime. Furthermore, when the locations of some data centers 30 are in summer season, the locations of the other data centers 30 may be in winter season. The data center 30 located at a place in daytime or summer time can be difficult in cooling computational resources and cause an increase in amount of computational resource, resulting in an increase in amount of electricity required for cooling the computational resources. In contrast, the data enter 30 located at a place in nighttime or winter time can easily cool computational resources because of lower atmospheric temperature, resulting in a small amount of electricity required for cooling the computational resources. Similarly, even in the case of the data center 30 located in a polar area at low temperature throughout the year, computational resources can be easily cooled and the amount of electricity required for cooling the computational resources can be kept small.

In the selection of the data center 30, furthermore, the electric power information received from each data center 30 may further include the information which can specify the amount of cooling power consumption when considering the power consumption required for cooling a computational resource. For example, this information may be the amount of cooling power consumption itself or the power performance ratio of the server. Alternatively, such information may be the cooling power consumption and the time required for a predetermined amount of processing performed in the server. In this case, the index-value calculation unit 10D sorts the data centers 30 using the sum of the amount of operating power consumption and the amount of cooling power consumption as an index value in ascending order of index values. Therefore, the selection unit 10E can select the data center 30 with a small amount of power consumption in operation and cooling of a computational resource when making comparison among the data centers 30 with respect to the same amount of processing performed on the computational resource. Therefore, the amount of power consumption due to the supply of computational resource can be further reduced. Furthermore, as is evident from the specific example of the aforementioned computational expression, the data center 30 can be selected in consideration of the power consumption required for cooling a computational resource as long as a value equivalent to the sum is substantially reflected on the computational expression of the index value even if the sum itself does not serve as an index value.

In general, an electric power company intends to decrease the maximum power supply from a power plant at a peak period in society as whole. Thus, the electricity rates are determined in stages, so that a higher electricity rate can be provided for daytime with higher power consumption and a lower electricity rate can be provided for nighttime with lower power consumption. Therefore, even in the case of consuming the same electric power, the data center located at a place in daytime is set to the high electricity rate, while the data center located at a place in nighttime is set to the low electricity rate.

Furthermore, if the electricity rate is considered in selection of the data center 30, the processing may be performed as follows: The index-value calculation unit 10D calculates the electricity rate required for supplying a computational resource in response to the providing request on the basis of the electricity rate per unit electric energy and the amount of power consumption required in predetermined amount of processing in the server. Furthermore, the selection unit 10E selects a data center 30 with a small index value, so that the data center with a low electricity rate can be selected when the data centers are compared with one another with respect to the processing of the same amount of computational resource. Therefore, costs required for supplying computational resources can be reduced.

In this case, it does not directly lead to the amount of power consumption of the data center. However, the selection of a data center located in a region in a time period of a cheaper electricity rate leads to the selection of a data center located in a region with lower power consumption in this time period. Therefore, it can contribute to equalization of power consumption through the whole society and lead to a reduction in energy for power generation.

Here, the load-distribution apparatus 10 receives the operating information of each data center 30 for every predetermined time and then stores the operating information in a storage device. Thus, the load-distribution apparatus 10 can select the data center 30 by only accessing data in the own apparatus 10 when receiving the providing request of the computational resource from the customer system 20. Therefore, a time period from transmitting the providing request of the computational resource from the customer system 20 to receiving the supply of computational resource can be shortened. In this case, the shorter the above predetermined time is (i.e., shorter the interval of receiving the operating information), the easier the exact selection of data center 30 can be performed depending on new information.

Furthermore, such operating information may be received when the providing request of computational resource is performed by the customer system 20. Alternatively, the operating information may be detected when a change in operating information is detected in the data center. Thus, load-distribution apparatus 10 can select a data center based on the newest information at the time of receiving the providing information of the computational resource from the customer system 20. Therefore, the amount of power consumption and the electricity rate can be reduced with a still higher degree of accuracy.

According to this load-distribution system, the load-distribution apparatus 10 can select only the data center that satisfies the performance requirement demanded by the customer system 20 as a data center provided for the supply of computational resource. Therefore, in the load-distribution system, the customer system can be adequately provided with a desired computational response and the quality of service for providing computational resource can be further improved. However, the load-distribution apparatus 10 does not necessarily perform processing in consideration of this performance requirement. In addition, the providing request of the computational resource does not need to include the performance requirement and the operating information does not need to include the performance information. The load-distribution system of the first embodiment includes one load-distribution apparatus. In contrast, al load-distribution system of a second embodiment may include two or more load-distribution apparatuses.

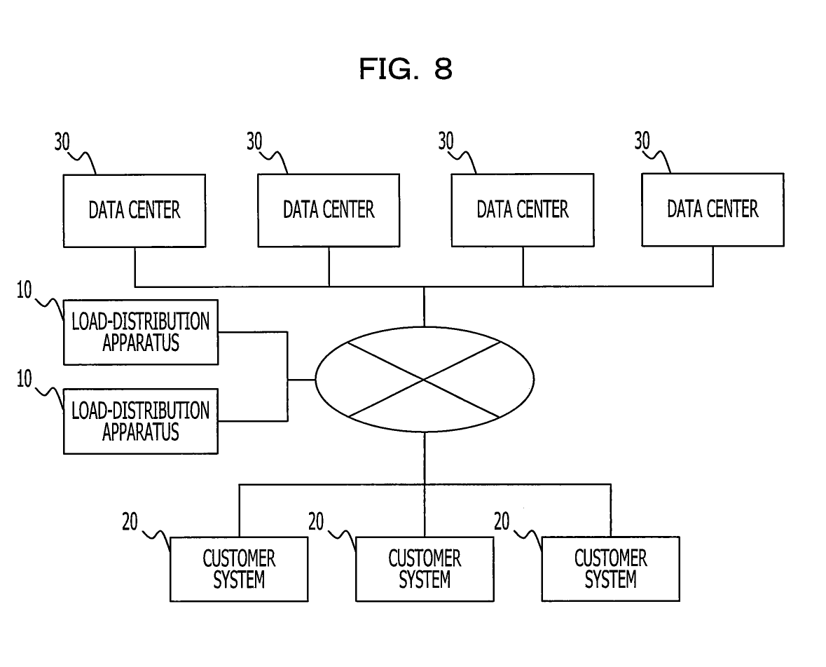

FIG. 8 is a diagram illustrating the entire configuration of a load-distribution system according to the second embodiment. The load-distribution system includes two or more load-distribution apparatuses 10, one or more customer systems 20, and two or more data centers 30.

The load-distribution apparatuses 10, the customer systems 20, and the data centers 30 are mutually connected with one another to form a network.

The load-distribution apparatuses 10, the customer systems 20, and the data centers 30 have the same configurations and functions as those illustrated in the first embodiment, respectively. Furthermore, in the case of the load-distribution system shown in FIG. 8, the customer system 20 selects any of the load-distribution apparatuses 10 and then transmits the providing request of the computational resource to the selected apparatus 10. At this time, among the load-distribution apparatuses 10, the customer system 20 can select a load-distribution apparatus 10 on which processing operations are not concentrated.

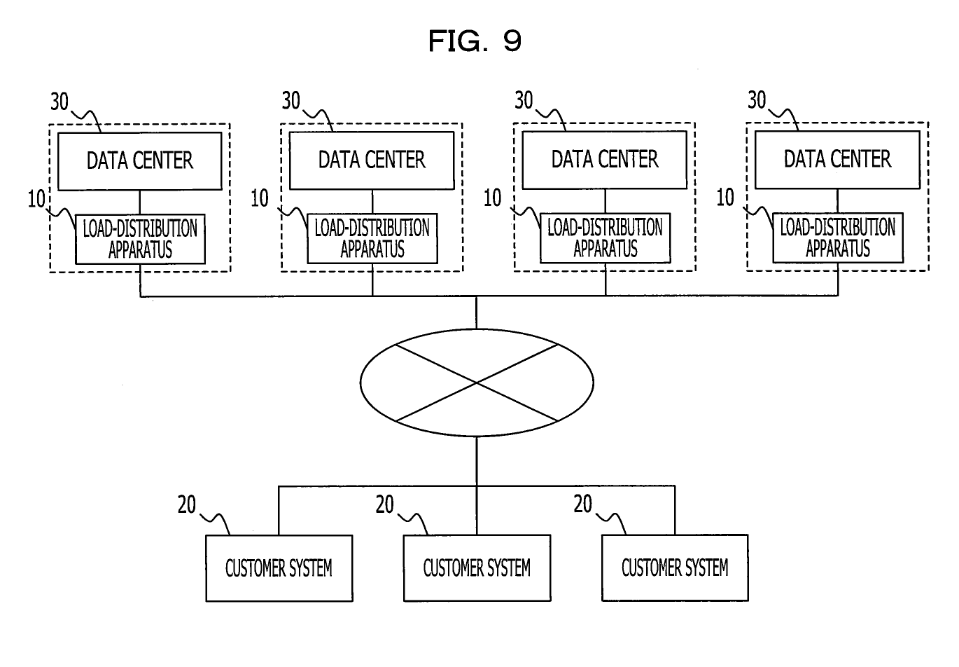

A load-distribution system shown in FIG. 9 is a modified example of the second embodiment. FIG. 9 illustrates the entire configuration of the load-distribution system in which load-distribution apparatuses 10 are arranged at the front ends of the respective data centers 31, respectively. Each of the customer system 20 transmits the providing request of the computational resource to any of the data centers 30. Then, the load-distribution apparatus 10 installed corresponding to this data center 30 receives the providing request of the computational resource, followed by performing the same processing as that of the first embodiment as described above. In other words, such a modified example also allows each of the load-distribution apparatuses 10 to employ a data center 30 corresponding to such an apparatus 10 or any of all the data centers 30 connected to the network as an object to be selected as a data center provided for the supply of computational resource.

The load-distribution system of the second embodiment exerts the following effects in addition to those of the load-distribution system of the first embodiment. In other words, the load-distribution apparatuses 10 of the second embodiment are installed in the load-distribution system of Example 2. The providing requests of the computational resources from a plurality of the customer systems 20 can be prevented from being concentrated on a certain load-distribution apparatus 10. Therefore, delay in processing, which is typically caused by the load-distribution apparatus 10, can be prevented.

### Third Embodiment

A load-distribution system according to a third embodiment of the present invention performs part of the processing of the load-distribution apparatus according to the first embodiment by a load-distribution apparatus installed corresponding to a customer system.

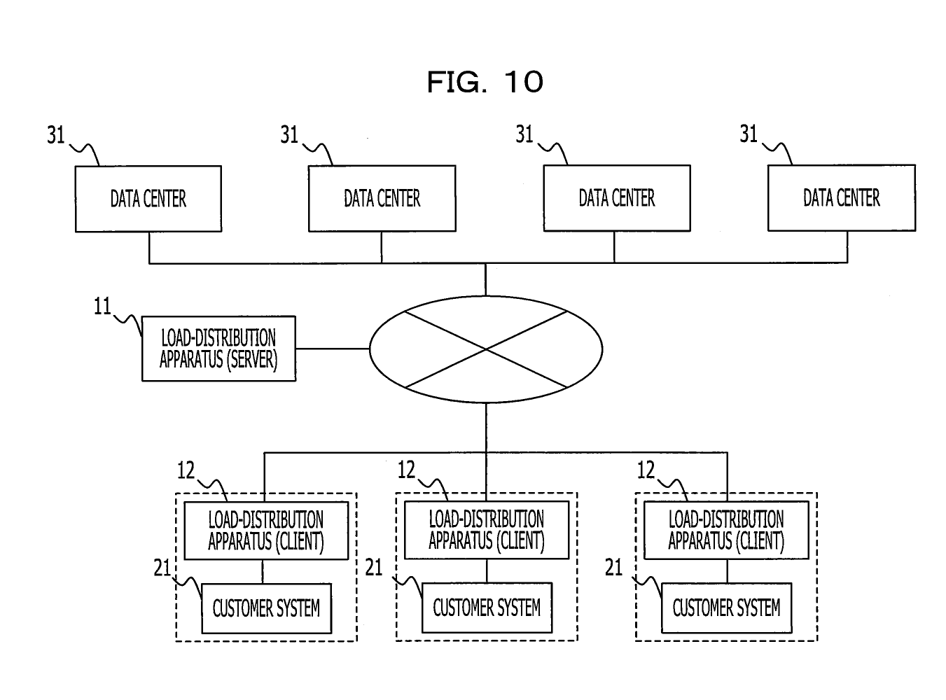

FIG. 10 illustrates the entire configuration of a load-distribution system according to the third embodiment. The load-distribution system includes a load-distribution apparatus 11, one or more customer systems 21, load-distribution apparatuses installed corresponding to the respective customer systems 21, and two or more data centers 31. The load-distribution apparatus 11, the load-distribution apparatuses 12, the customer systems 21, and the data centers 31 are mutually connected to one another to form a network.

The load-distribution apparatus 11 is a server provided with at least a CPU and a storage device. The load-distribution apparatus 11 receives operating information from each data center 31 and then stores the operating information every predetermined time. In addition, the load-distribution apparatus 11 specifies a data center 31 that satisfies performance requirements based on the performance information of the respective data centers 31 stored in the storage device when the request of operating information of a computational resource is received from the load-distribution apparatus 12 in addition to the performance requirement of the computational resource requested by the customer system 23. Furthermore, the load-distribution apparatus 11 calculates the index value of the specified data center 31 and then transmits the calculated index value to the customer system 21.

The load-distribution apparatus 12 is a client provided with at least a CPU and a storage device. The load-distribution apparatuses 12 are installed corresponding to the respective customer systems 21 and receives a providing request of computational resources including the performance requirements from the customer systems 21. The load-distribution apparatuses 12 receive information representing index values of data centers 31 adaptable to the performance requirements from the load-distribution apparatus 11. Then, the data center provided for the supply of computational resource 31 is selected based on the information. Furthermore, the load-distribution apparatus 12 transmits the providing request of the computational resource to the selected data enter 31.

The customer system 21 transmits the providing request of the computational resource including performance requirements to the load-distribution apparatus 12. The data centers 31 include computational resources, such as servers and storages, respectively. Furthermore, each data center 31 transmits operating information to the load-distribution apparatus 11 every predetermined time. In addition, each of the data centers 31 constructs a virtual computational resource using physical computational resources included in the data center 31 when it receives from the load-distribution apparatus 12 a providing instruction of computational resource to the customer system 21. Furthermore, the data center 31 offers the constructed virtual computational resource to the customer system 21 through the network.

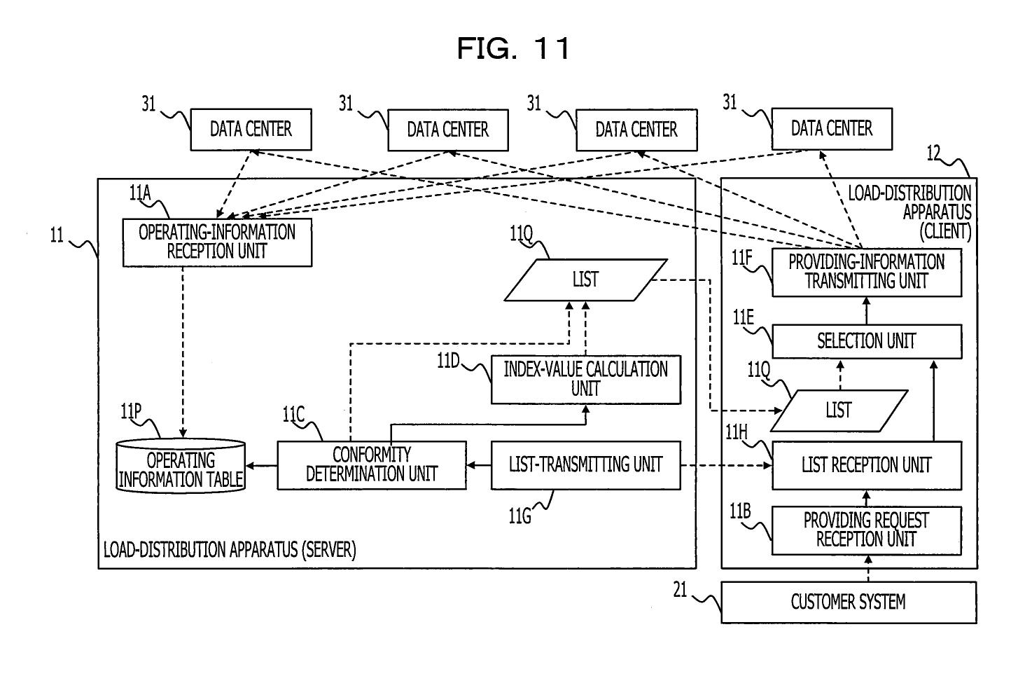

In the figure, furthermore, the load-distribution apparatus 11 is represented as a load-distribution apparatus (server) and the load-distribution apparatuses 12 are represented as load-distribution apparatuses (clients). Next, the configuration of the load-distribution apparatus 11 and the configuration of the load-distribution apparatus 12 will be described. FIG. 11 is a block diagram illustrating the load-distribution apparatus 11 and the load-distribution apparatus 12.

The load-distribution apparatus 11 includes an operating information table 10P. The operating information table 10P is held in a storage device installed in the load-distribution apparatus 10. In addition, a load-distribution program is executed by the CPU of the load-distribution apparatus 11 and then cooperates with hardware devices, such as the storage device, an input/output device, and a communication port. As a result, an operating-information reception unit 11A, a providing-request reception unit 11C, a conformity determination unit 11D, and a list-transmitting unit can be realized.

The operating information table 11P, operating-information reception unit 11A, conformity determination unit 11C, and index-value calculation unit 11D have the same functions as those of the operating information table 10P, operating-information reception unit 10A, conformity determination unit 10C, and index-value calculation unit 10D in the first embodiment, respectively. In addition, a list 11Q is the same as the list 10Q in the first embodiment. Therefore, their descriptions will be omitted.

The list-transmitting unit 11G receives a request for the operating information of the data center 31 adapted to the performance request in addition to the performance request of the computational resource requested by the customer system 21 through a communication port connected to the customer system 21. In addition, the list-transmitting unit 11G transmits the list 11Q, which is generated from the conformity determination unit 11C, as the operating information of the data center 31 to the customer system 21.

On the other hand, the CPU of the load-distribution apparatus 12 executes a load-distribution program and then cooperates with hardware devices, such as a storage device, an input/output device, and a communication port. As a result, a providing-request reception unit 11B, a selection unit 11E, a providing-information transmitting unit 11F, and a list reception unit 11H are realized.

The providing-request reception unit 11B, selection unit 11E, and providing-information transmitting unit 11F have the same functions as those of the providing-request reception unit 10B, selection unit 10E, and providing-information transmitting unit 10F of the first embodiment, respectively. Therefore, their descriptions will be omitted.

A list-receiving unit 11H transmits a request of the operating information of data center 31 adapted to the performance requirement to the load-distribution apparatus 11 when the providing request of the computational resource and the performance requirement of the computational resource are received from the customer system 21 in the providing-request receiving unit 11B. In addition, from the load-distribution apparatus 11, the list-receiving unit 11H receives a list 11Q in which index values correspond to the respective data centers 31.

Next, the processing performed by each of the load-distribution apparatus 11 and the load-distribution apparatus 12 will be described. Here, the processing of the load-distribution apparatus 11 at the time of receiving the operating information from the data center 30 is the same as one illustrated by the flowchart of the first embodiment shown in FIG. 5, so that the description thereof will be omitted.

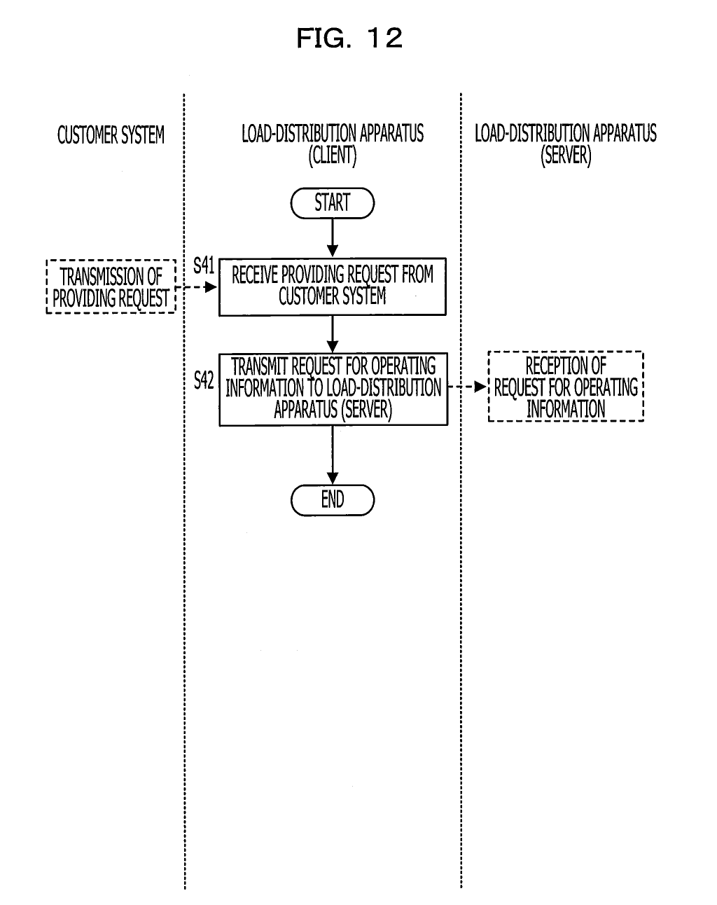

FIG. 12 is a flowchart representing the processing of the load-distribution apparatus 12 when the providing request of the computational resource is received from the customer system 21. The providing-request reception unit 11B receives the providing request of the computational resource from the customer system 21 (S21). Then, the providing-request reception unit 12B holds the contents of the providing request of the computational resource on the storage device installed in the load-distribution apparatus 12 (S41).

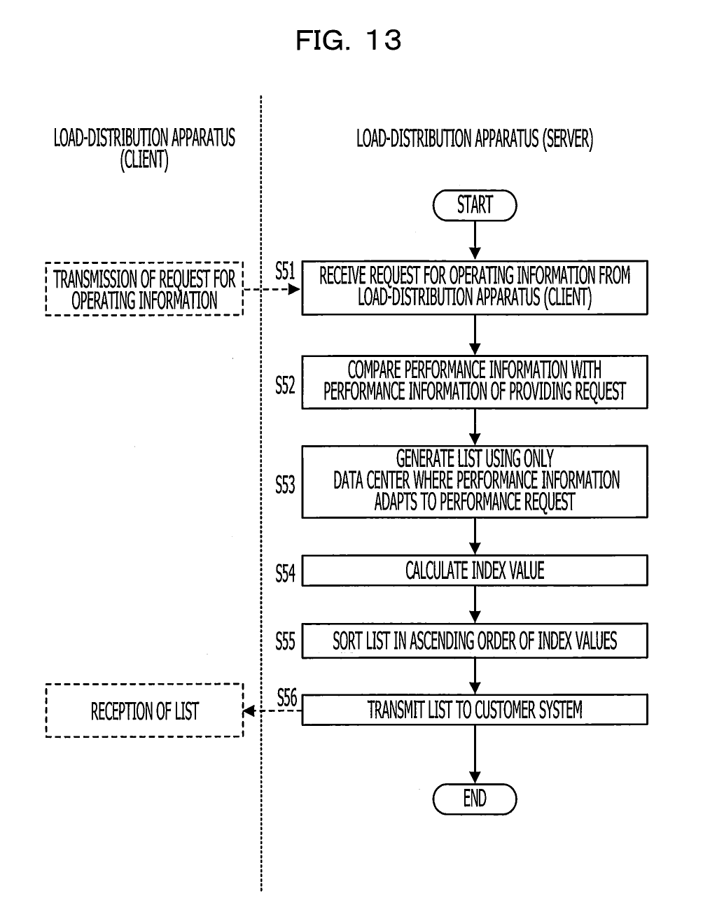

The list-receiving unit 11H transmits the request of operating information of the data center 31 adapted to the performance requirement (S42). FIG. 13 is a flowchart representing the processing of the load-distribution apparatus 11 when the request of operating information of the data center 31 is received from the load-distribution apparatus 12.

In addition, the list-transmitting unit 11G receives the request of operating information from the load-distribution apparatus 12 (S51). Then, the list-receiving unit 11G holds the contents of the providing request of the computational resource on the storage device installed in the load-distribution apparatus 11.

Steps S52 to S55 are the same as the steps S22 to S25 of the first embodiment shown in FIG. 6, so that the descriptions thereof will be omitted. The list-transmitting unit 11G transmits the list 11 Q to the customer system 21 corresponding to the load-distribution apparatus 11 (S56).

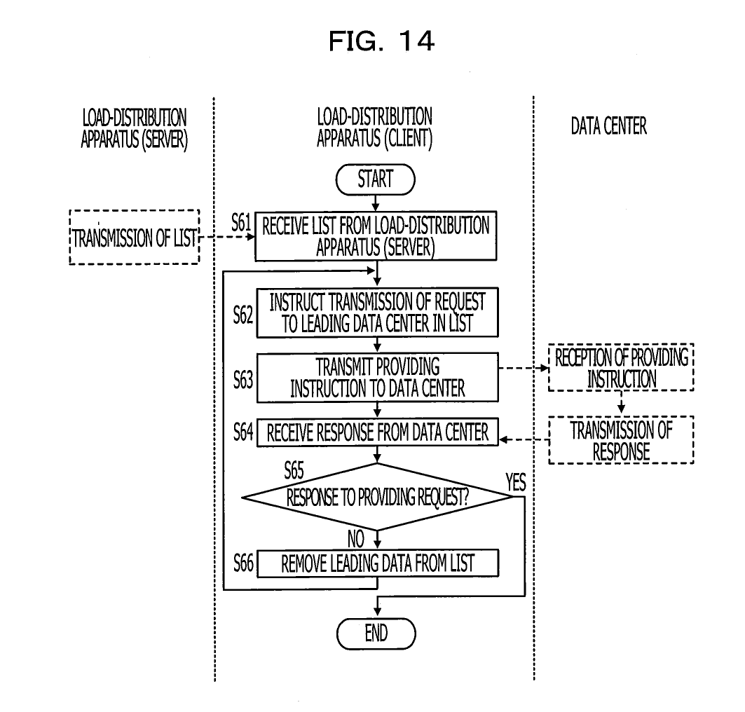

FIG. 14 is a flowchart representing the processing of the load-distribution apparatus 12 when receiving the list 11Q from the load-distribution apparatus 11. The list-receiving unit 11H receives the list 11Q from the load-distribution apparatus 11 (S61). Then, the list-receiving unit 11H holds the received list 11Q on the storage device installed in the load-distribution apparatus 12.

Steps S62 to S66 are the same as the steps S26 to S30 of the first embodiment shown in FIG. 6, so that the descriptions thereof will be omitted. Thus, the load-distribution apparatuses 12 installed corresponding to the respective customer systems 21 select the data centers 31 to reduce the burden of processing in the load-distribution apparatus 11. The providing requests of the computational resources from a plurality of the customer systems 21 can be prevented from making the load-distribution apparatus 11 bottleneck even if the providing requests of the computational resources are concentrated at certain timing in a plurality of customer systems 21. Therefore, the data center 31 can be efficiently selected throughout the entire system.

Here, the contents of the performance requirement which each customer system 21 requires may be held in the storage device of the load-distribution apparatus 11. In addition, the load-distribution apparatus 11 may transmit the list 11Q periodically to the customer system 21. Furthermore, in the customer system 21, the periodically received list 11Q is stored in the storage device and the above processing may be then performed with reference to the table. Therefore, the possibility that the processing requests are concentrated in the load-distribution apparatus 11 at certain timing can be further reduced.

In addition, the load-distribution apparatus 11 may receive the operation information of each data center 31 when the operating information is requested by the customer system 21. In this way, the load-distribution apparatus 11 can generate the list 11 Q based on the newest information.

Therefore, the load-distribution apparatus 12 receiving the list 11Q makes possible to accurately select the data center provided for the supply of computational resource.

Furthermore, like the second embodiment, the load-distribution system of the third embodiment may also include two or more load-distribution apparatuses 11. Here, in all of the above embodiments, the computational resources to be supplied from the data centers to the customers may be different depending on the modes of service. For example, if the mode of service is “Infrastructure as a Service” (IaaS), the data center supplies a virtual machine itself to the customer system. In this case, the customer may maintain and operate the operating system (OS) and application of the server. Furthermore, if the mode of service is “Platform as a Service” (PaaS), the data center creates an execution environment for application selected by the customer. Then the data center provides the customer system with the execution environment while maintaining and operating the execution environment. In this case, the customer may maintain and operate the application of the server. Furthermore, if the mode of service is “Software as a Service” (SaaS), each data center maintains and operates the application as well as the execution environment thereof, followed by supplying only the functions of the application to the customer system. The load-distribution system in each of the above embodiments can correspond to any of the modes of service.

Furthermore, in all of the above embodiments, when the respective specific groups of computational resources in the data center have their own different contents of the performance information and electric power information, even a computational resource physically installed in one data center may be handled after virtually dividing into computational resources of different data centers. Then, the load-distribution apparatus may receive operating information for each of the virtually divided data centers. In one specific example, the different floors of the same data center may have their own servers with different power performance ratios.

In the above system, the data center provided for the supply of computational resource is selected based on the information about power consumption required for operating a computational resource installed in each data center. Therefore, it becomes possible to select a data center in consideration of power consumption and operate a suitable computational resource.

According to an aspect of an embodiment, a client and/or a server may be implemented as a function within one computer and/or implemented as a function on two or more computers in network communication.

According to an aspect of the embodiments of the invention, any combinations of one or more of the described features, functions, operations, and/or benefits can be provided. A combination can be one or a plurality. The embodiments can be implemented as an apparatus (a machine) that includes computing hardware (i.e., computing apparatus), such as (in a non-limiting example) any computer that can store, retrieve, process and/or output data and/or communicate (network) with other computers. According to an aspect of an embodiment, the described features, functions, operations, and/or benefits can be implemented by and/or use computing hardware and/or software. The apparatus (e.g., the data center 30, load-distribution apparatus 10, customer system 20, etc.) can comprise a controller (CPU) (e.g., a hardware logic circuitry based computer processor that processes or executes instructions, namely software/program), computer readable media, transmission communication interface (network interface), and/or an output device, for example, a display device, all in communication through a data communication bus. In addition, an apparatus can include one or more apparatuses in computer network communication with each other or other apparatuses. In addition, a computer processor can include one or more computer processors in one or more apparatuses or any combinations of one or more computer processors and/or apparatuses. An aspect of an embodiment relates to causing one or more apparatuses and/or computer processors to execute the described operations. The results produced can be output to an output device, for example, displayed on the display.

A program/software implementing the embodiments may be recorded on a computer-readable media, e.g., a non-transitory or persistent computer-readable recording medium. The program/software implementing the embodiments may be transmitted over a transmission communication path, e.g., a wire and/or a wireless network implemented via hardware. An example of communication media via which the program/software may be sent includes, for example, a carrier-wave signal.

Any of network technologies known in the art is applicable to the network of any of the above embodiments, which makes a connection among the customer system, the load-distribution apparatus, and the data center. Such a network may be, for example, Internet or an exclusive line.

Furthermore, the customer system of any of the above embodiments may have any kind of configuration. For example, the customer system may include a plurality of servers and clients which are connected to one another through the network even if the customer system includes only one computer.

In any of all the embodiments described above, a load-distribution program may be stored in a non-transitory computer-readable recording medium, such as a magnetic tape, a magnetic disk, a magnetic drum, an IC card, CD-ROM, or DVD-ROM. Therefore, a load-distribution program stored in the non-transitory recording medium may be installed in a load-distribution apparatus to execute the load-distribution program.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A non-transitory computer-readable recording medium storing therein a load-distribution program that causes a computer to execute a procedure, where a plurality of data centers construct and provide computational resources to a customer system by a network, the procedure comprising:
receiving from a customer system a computational resource request;
acquiring electric power information for each data center, which can specify an amount of power consumption required for providing a computational resource by each data center, when receiving the computational resource request of the customer system;
selecting one or more data centers from the plurality of data centers based on the amount of power consumption; and
transmitting to the selected data center a request to provide the computational resource to the customer system.

2. The non-transitory computer-readable recording medium according to claim 1, wherein
the acquiring acquires electricity rate information which can specify an electricity rate per unit of electric energy in each data center,
wherein with reference to the amount of power consumption and the electricity rate per unit of electric energy of each data center, the selecting calculates an electricity rate at a time of supplying from each data center the computational resource in response to the computational resource request and selects a data center having a lower electricity rate than other data centers.

3. The non-transitory computer-readable recording medium according to claim 1, wherein
the amount of power consumption includes an amount of operating power consumption, which is an amount of electricity required for performing a predetermined amount of processing by a server served as a computational resource to be subsequently supplied from each data center,
wherein the selecting selects a data center based on the amount of the operating power consumption.

4. The non-transitory computer-readable recording medium according to claim 1, wherein
the amount of power consumption further includes an amount of cooling power consumption required for cooling a server when the server is served as a computational resource to be subsequently supplied from each data center and performs a predetermined amount of processing,
wherein the selecting selects a data center based on a sum of the amount of power consumption and the amount of cooling power consumption.

5. The non-transitory computer-readable recording medium according to claim 1, wherein
the receiving receives a performance requirement representing a performance required for the computational resource corresponding to the computational resource request,
wherein the acquiring acquires performance information representing performance of a computational resource installed in each data center,
wherein the selecting makes a comparison between the performance information and the performance requirement with respect to each data center to specify only a data center having a computational resource with a performance adapted to the performance requirement, and selects a data center provided for supply of computational resource from the specified data centers.

6. The non-transitory computer-readable recording medium according to claim 1, wherein
the acquiring receives the electric power information from each data center every predetermined time and stores the electric power in a table, and acquires the electric power information with reference to the table when receiving the computational resource request.

7. The non-transitory computer-readable recording medium according to claim 1, wherein
the acquiring acquires the electric power information from each data center by receiving the electric power information when the computational resource request is received.

8. The non-transitory computer-readable recording medium according to claim 1, wherein
the selecting selects another data center from the selected data centers when receiving a response of rejecting a supply of a computational resource in response to the transmitted computational resource request.

9. A load-distribution apparatus communicably connectable to a plurality of data centers, where a data center constructs a computational resource based upon virtualization of physical computational resources and provides a customer system with the computational resource by a network, the apparatus comprising:
a processor
receiving a computational resource request from the customer system,
acquiring electric power information for each data center, which can specify an amount of power consumption required for providing a computational resource by each data center,
selecting one or more data centers from the plurality of data centers based on the amount of power consumption, and
transmitting to the selected data center a request to provide the computational resource to the customer system.

10. A load-distribution method to be performed by a computer in communication with a plurality of data centers, where a data center constructs a computational resource based upon virtualization of physical computation resources and provides a customer system with the computational resource by a network, the method comprising:
receiving from a customer system a computational resource request;
acquiring electric power information for each data center, which can specify an amount of power consumption required for providing a computational resource by each data center, when receiving the computational resource request;
selecting one or more data centers from the plurality of data centers based on the amount of power consumption; and
transmitting to the selected data center a request to provide the computational resource to the customer system.
